(19) United States
(12) Patent Application Publication
(10) Pub. No.: US 2015/0139658 A1
(43) Pub. Date: May 21, 2015

(54) ADAPTIVE MULTI-CHANNEL TRANSMITTER WITH CONSTANT DATA THROUGHPUT

(71) Applicants: Bengt-Erik Olsson, Hovas (SE); Christina Larsson, Molndal (SE)

(72) Inventors: Bengt-Erik Olsson, Hovas (SE); Christina Larsson, Molndal (SE)

(73) Assignee: TELEFONAKTIEBOLAGET L M ERICSSON (PUBL), Stockholm (SE)

(21) Appl. No.: 14/403,318

(22) PCT Filed: May 25, 2012
(86) PCT No.: PCT/EP2012/002249

§ 371 Date: Nov. 24, 2014

(51) Int. Cl. H04L 27/34; H04L 5/00; H04L 27/20; H04L 27/36; H04B 10/2575; H04L 1/00

(52) U.S. Cl. CPC H04L 27/3405; H04B 10/2575; H04L 1/0015; H04L 1/0002; H04L 27/2057; H04L 27/362; H04L 5/006
USPC 398/115

(57) ABSTRACT

The present disclosure is directed to a transmitter arrangement 200; 400 and a method therein for transmitting a signal O_{B} comprising a number of data streams D1, D2, D3, D4 and a number of sub-channels BP1, BP2, BP3, BP4; QP1, QP2; QA1 to a receiver 150 via a transmission link 140. The method comprises the actions of: obtaining link quality information indicative of the transmission conditions for the transmission link 140, and determining the number of sub-channels for the output signal based on obtained the transmission conditions such that the transmitted data throughput via the transmission link 140 remains the same and such that the transmitted data throughput is equally distributed between the determined number of sub-channels.

### TECHNICAL FIELD

This disclosure relates to a method for transmitting a multichannel signal and a transmitter arrangement for performing the method.

### BACKGROUND

High capacity communication via optical fiber is commonly used in optical networks of today. Such high capacity communication is particularly suitable for handling the rapidly growing communication of various multimedia services or similar requiring high bandwidth. In view of this there has been an increasing interest for transporting large volumes of information with high spectral efficiency in the optical domain.

Therefore, optical transmission systems of today are commonly using advanced modulation formats, e.g. such as Binary Phase Shift Keying (BPSK), Quadrature Phase Shift Keying (QPSK), 16 Quadrature Amplitude Modulation (16-QAM) and 64 Quadrature Amplitude Modulation (64 QAM) or similar. The information communicated by such advanced modulation formats is represented by the state of the amplitude and phase of the optical field, rather than the state of the optical intensity as have been done before.

The arrival of advanced optical modulation schemes, like BPSK, QPSK, 16-QAM and 64 QAM or similar, together with polarization multiplexing and coherent optical receivers have opened up many new possibilities to optimize optical networks. Such modulation formats have enabled higher throughput (total data rate) since the formats offer higher spectral efficiency compared to traditional On-Off Keying (OOK) or similar. However, higher spectral efficiency comes with the price of higher required Optical Signal to Noise Ratio (OSNR) for the same Bit-Error-Rate (BER) as OOK. Thus the maximum transmission distance is significantly shorter for 16-QAM (4 bits per symbol) compared to QPSK (two bits per symbol) or BPSK (one bit per symbol). Dual polarization (DP) 16-QAM requires about 4 dB higher OSNR than DP-QPSK for the same BER which obviously translates into much shorter possible transmission distance. Depending on system design, DP-QPSK can easily provide several thousands of kilometers (km) while DP-16QAM is limited to below 1000 km at 100 Gbit/s per wavelength channel in a dense wavelength division multiplexed system.

In current networks, using advanced modulation schemes as indicated above, the link configuration is fairly static and wavelength routes are calculated in advanced and only modified if necessary. Typically, a modification of the link configuration is very time consuming. Thus optical transponders (transmitter and receiver modules) are selected with specific throughput and modulation formats depending on the throughput and reach required in the particular use case.

Next generation networks are anticipated to be much more dynamic and wavelength routes may be reconfigured automatically as bandwidth requirements changes depending on actual user needs. Thus there is a need for transponders that can adapt the modulation format depending on current requirements of a particular wavelength route.

In addition there is also a strong requirement from network operators to be able to pack wavelength channel routes close to each other in a dynamic fashion. Today the optical wavelength spectrum is divided into fixed wavelength slots, e.g. 40 GHz slots on a 50 GHz grid. (Optics people tend to talk in wavelength (nm) when referring to a data channel generated by a laser and in GHz when referring to the available bandwidth and grids of wavelength channels.) Unfortunately these fixed slots limit the freedom of adapting the fiber spectrum utilization. As an example, a wavelength route requiring only 10 Gbit/s occupies as much optical bandwidth as a 100 Gbit/s DP-QPSK or 200 Gbit/s DP-16QAM data channel. Thus mixed modulation formats on network traffic reduces the over all bandwidth utilization of the network. Therefore operators expect that next generation networks should abandon the fixed wavelength grid and allow dynamic spectrum allocation for each wavelength route. The goal is then to have transponders that can adapt the modulation format and spectral efficiency depending on the need for a particular wavelength route.

### SUMMARY

As indicated above, there may be a need for transmitter that can adapt the modulation format depending on the requirements of a particular wavelength route. As also indicated above there may be a need for packing wavelength channel routes close to each other in an adaptive or dynamic fashion.

One way of adapting to less favorable conditions of a wavelength route may be to switch to a lower throughput by reducing the number of bits in a transmitted symbol, e.g. moving from 16-QAM to QPSK will reduce the throughput with 50%. However, in reality the network may still require the same data throughput and thus this solution is less favorable. Another option may be to increase the baud-rate (i.e. the symbol rate) accordingly for lower symbol modulation formats, which in turn will increase the required bandwidth. However, this may not always be realistic since e.g. the Digital-to-Analog-Converter (DAC) must be designed with the bandwidth that is required for the least spectral efficient format. Usually the cost of the DAC grows exponentially with bandwidth why it may not be a cost efficient solution.

According to some embodiments of the present solution a choice between spectral efficiency and bandwidth requirement can be optimized depending on the capacity of the channel over which the signal is to be transmitted. Embodiments of the solution provide advantages such as scalability and re-use of substantially the same hardware etc.

At least some of the drawbacks indicated above have been eliminated or mitigated by an embodiment of the present solution providing a method for . . .

At least some of the drawbacks indicated above have also been eliminated or mitigated by another embodiment of the present solution providing a transmitter arrangement configured to operatively . . .

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that the methods defined in the specification or the appended claims may comprise further steps in addition to those mentioned. In addition, the steps mentioned may, without departing from the present solution, be performed in other sequences than those given in the specification or the claims.

Further advantages of the present invention and embodiments thereof will appear from the following detailed description of the solution.

### BRIEF DESCRIPTION OF THE DRAWINGS

FIG. 1a is a schematic illustration of a known I/Q-modulator arrangement 10 configured to operatively modulate a data stream Dx;

FIG. 1b shows exemplifying interior components of the modulator 10 in FIG. 1a;

FIG. 1c is a schematic illustration of four (4) exemplifying constellation points A, A′, B, B′ that can be accomplished using the I/Q-modulator arrangement 10;

FIG. 2 is a schematic illustration of a transmitter arrangement 100 according to an embodiment of the present solution;

FIG. 3 is a schematic illustration of a transmitter arrangement 200 according to an embodiment of the present solution;

FIG. 4 is a schematic illustration of a transmitter arrangement 300 according to an embodiment of the present solution;

FIG. 5 is a schematic illustration of a transmitter arrangement 400 according to an embodiment of the present solution;

FIG. 6 is a schematic illustration of a transmitter arrangement 500 according to an embodiment of the present solution;

FIG. 7 is a schematic flowchart which illustrates the operation of exemplifying embodiments of the present solution.

### DETAILED DESCRIPTION OF EMBODIMENTS

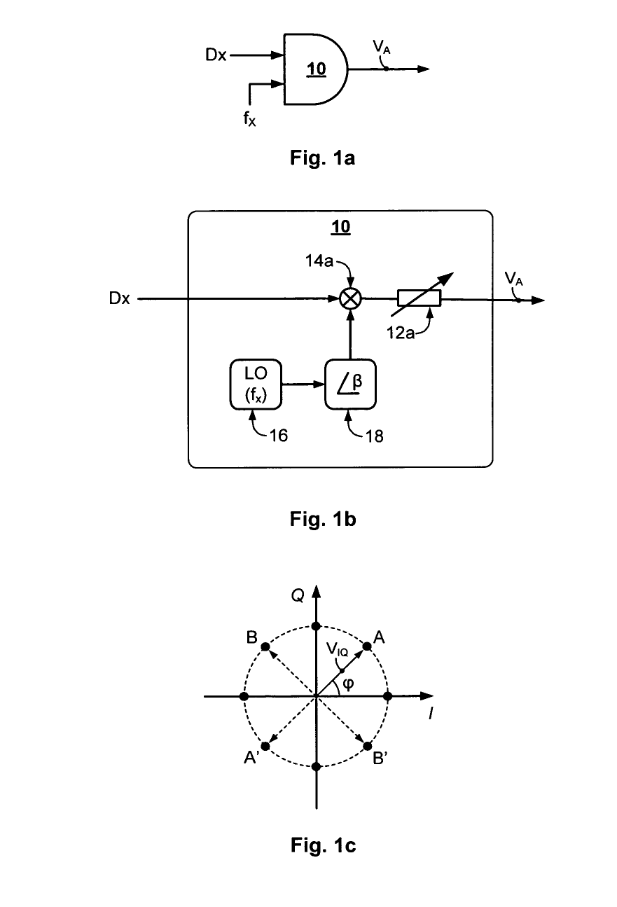

FIG. 1a shows an exemplifying known modulator arrangement 10 configured to operatively modulate a data stream Dx. The modulator arrangement 10 may be e.g. an analogue modulator configured to modulate an analogue data stream Dx or a digital modulator configured to modulate a digital data stream Dx.

FIG. 1b shows exemplifying interior components of the modulator arrangement 10 in FIG. 1a. Here it is assumed that the modulator arrangement 10 is an analogue mixer, though a digital multiplier or similar (e.g. an EXOR-gate arrangement or similar) may be used as an alternative. As schematically indicated in FIG. 1b, the data stream Dx may modulate an electrical LO-signal of frequency fₓ produced by an oscillator 16. A first mixer 14a mixes the data stream Dx with the LO-signal in-phase. A phase shifting device 18 is used to mix the data stream Dx with the LO-signal being phase shifted by e.g. β=+/−90° or similar. The amplitude of the output signal VA may be increased or decreased by using an amplifier 12a.

The above described manner and other manners of producing a modulated and possibly phase-shifted output signal a signal such as the data stream Dx are well known to those skilled in the art and it needs no detailed description as such.

FIG. 1c is a schematic illustration of four (4) exemplifying constellations points A, A′, B, B′ that can be accomplished using an modulator arrangement 10 or similar. In FIG. 1c it is assumed that the modulator arrangement 10 produces a vector V_{IQ} with constant amplitude, while the phase φ of the vector is varied such that substantially any position on an imaginary circle can be accomplished. The vector V_{IQ} shown in FIG. 1c is schematically placed in a Cartesian coordinate system, wherein the x-axis represents the amplitude of the in-phase component I and the y-axis represents the amplitude of the quadrature component Q.

Those skilled in the art are well aware of the fact that a quadrature signal is a signal that comprises an in-phase component I and a quadrature phase component Q of an originating signal.

In FIG. 1c the phase φ of the vector V_{IQ} is assumed to be 45° in a first exemplifying constellation point A, and 225° (i.e. 45°+180°) in a second exemplifying constellation point A′. Similarly, the phase φ of the vector V_{IQ} is assumed to be 135° (i.e. 90°+45°) in a third exemplifying constellation point B and −45° (or 270°+45°) in a fourth exemplifying constellation point B′. Thus, the first constellation point A is 180° out of phase with respect to the second constellation point A′ and the third constellation point B is 180° out of phase respect to the fourth constellation point B′. As will be elaborated in more detail later, this corresponds to an example of a Quadrature Phase Shift Keying (QPSK) modulation scheme or similar.

Those skilled in the art realize that substantially any constellation point can be accomplished by a modulator arrangement of the kind schematically indicated in FIGS. 1a, 1b or similar. For example, substantially any phase φ of the vector V_{IQ} between 0-360° can be accomplished. Similarly, substantially any length (amplitude) of the vector V_{IQ} can be accomplished by adjusting the amplification or attenuation of the amplifier 12a. The maximum and minimum length (amplitude) and the phase φ are determined by the properties of the modulator arrangement 10 in question.

It may be preferred that the modulator arrangement 10 does not comprise the amplifier 12a or has an amplifying arrangement with a fixed amplification or similar, thus only providing a vector V_{IQ} with constant length while the phase φ of the vector V_{IQ} may be varied by simply varying the phase shift β of the LO-signal using the phase shifting device 18.

### First Embodiment

### Transmitter Arrangement 100

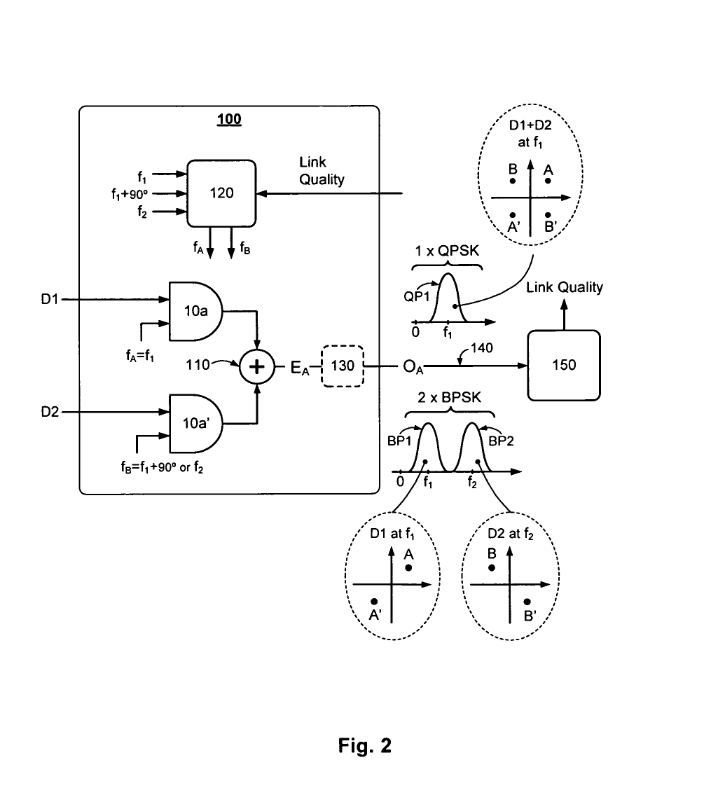

The attention is now directed to FIG. 2 showing a schematic illustration of a transmitter arrangement 100 according to an embodiment of the present solution. The transmitter arrangement 100 is configured to operatively transmit an optical signal O_{A} or an electrical signal E_{A} comprising two data streams D1, D2 distributed on a number of sub-channels. Electrical signals mentioned herein may be a wired signal or a wireless signal or similar. It is preferred that the transmitter 100 is configured to operatively transmit the signal to a suitable receiver arrangement 150 via a suitable transmission link 140.

The transmission link 140 may e.g. be an optical fiber or similar in case of an optical signal O_{A} or a waveguide or an air interface or similar in case of an electrical signal E_{A}.

The transmitter arrangement 100 is configured to obtain link quality information indicating the current transmission conditions for the transmission link 140. The transmitter arrangement 100 is configured to operatively determine a number of sub-channels in the signal O_{A} or similar based on the obtained transmission conditions, preferably such that the transmitted data throughput via the transmission link 140 remains unchanged and/or preferably such that the transmitted data throughput is equally distributed between the determined number of sub-channels.

The exemplifying transmitter arrangement 100 comprises a first modulator arrangement 10a, a second modulator arrangement 10b, a summation unit 110, a determining unit 120 and preferably also an optical modulator arrangement 130.

The first modulator arrangement 10a and the second modulator arrangement 10b are preferably I/Q-modulators, e.g. of the same or similar kind as modulator 10 described above with reference to FIGS. 1a-1c. The first modulator arrangement 10a is preferably configured to operatively receive a signal comprising a first data stream D1 and a signal comprising a first frequency f_{A} and to produce a modulated signal of the received data stream D1. Similarly, the second modulator arrangement 10b is preferably configured to operatively receive a signal comprising a second data stream D2 and a signal comprising a second frequency f_{B} and to produce a modulated signal of the received data stream D2.

It is preferred that the summation unit 110 is configured to operatively summarize the first modulated signal from the first modulator arrangement 10a and the second modulated signal from the second modulator arrangement 10b so as to provide an electrical summarized output signal E_{A}.

The electrical output signal EA may be transmitted directly via the transmission link 140 being a wave guide or an air interface or similar. Alternatively the signal E_{A} may be provided to an optical modulator arrangement 130 configured to operatively modulate the signal E_{A} so as to form and transmit an optical output signal O_{A} via the transmission link 140 being an optical fiber or similar. Optical modulation of signals, such as signal E_{A} or similar, is well known to those skilled in the art and it needs no further description. The optical modulator arrangement 130 may be any known optical modulator, e.g. based on one or more Mach-Zehnder modulators or similar.

The attention is now directed to the determining unit 120 of the transmitter arrangement 100. It is preferred that the determining unit 120 is configured to operatively produce or receive a unique signal comprising a unique frequency for each data stream D1, D2 that is received by the transmitter arrangement 100. The determining unit 120 may e.g. be configured to produce or receive a first unique signal at a first unique frequency f₁ for data stream D1 and a second unique signal at a second unique frequency f₂ for data stream D2. In addition, it is preferred that the determining unit 120 is configured to operatively produce or receive an unique phase-shifted signal for each unique signal (f₁, f₂) or at least for half of the unique signals or some other set of the unique signals as required in the specific embodiment of the present solution. The determining unit 120 may e.g. be configured to operatively produce or receive a first unique phase-shifted signal f₁+90° comprising a phase shifted version of the first unique signal at frequency f₁.

It is preferred that each unique phase shifted signal is phase-shifted so as to receive a phase that is orthogonal with respect to the phase of the corresponding unique signal—e.g. phase-shifted +90° with respect to the corresponding unique signal—so as to produce an unique quadrature phase signal of the corresponding unique in-phase signal. Other phase shifts are conceivable, e.g. −90° or similar as may be suitable in the specific embodiments of the present solution.

It is also preferred that the determining unit 120 comprises one output connected to each modulator arrangement respectively, e.g. one output f_{A}, f_{B} connected to modulator arrangement 10a, 10b respectively.

The receiver arrangement 150 may be any suitable known receiver configured to receive the output signal or similar from the transmitter arrangement 100 via the via the transmission link 140. The receiver 150 may e.g. be an optical receiver or similar in case of an optical output signal O_{A} or a microwave receiver or similar in case of an electrical output signal E_{A}. Those skilled in the art having the benefit of this disclosure will have no difficulty in choosing a suitable receiver 150 based on the character of the signal O_{A} or E_{A} or similar transmitted from the transmitter arrangement 100.

The receiver arrangement 150 may be configured to operatively determine link quality information indicating the current transmission conditions for the transmission link 140 and to operatively provide this information to the receiver arrangement 100. Link quality information indicating the current transmission conditions for the transmission link 140 may be obtained by the receiver arrangement 150 in any well known manner, e.g. by obtaining the Signal to Noise Ratio (SNR), or Signal to Interference plus Noise Ratio (SINR), or Bit Error Rate (BER), or Block Error Rate (BLER) or similar for the received signal O_{A} or similar. Thus, the transmitter arrangements and/or the determining units mentioned herein may receive link quality information from the receiver arrangement 150. Alternatively or additionally, the transmitter arrangements and/or the determining units mentioned herein may themselves be configured to operatively obtain link quality information for the transmission link 140. This may e.g. be done by analyzing signals received via the transmission link 140, e.g. obtaining the SNR or SINR or BER or BLER or similar for such signals.

In addition, link quality information may be deduced by empirical means or similar, e.g. by means of measurements and/or simulations and/or calculations or similar. This is particularly advantageous in case the link quality is expected be fairly stable in practical use.

The attention is now directed to an exemplifying operation of the transmitter arrangement 100.

### First Modulation Scheme of Transmitter Arrangement 100

The transmitter arrangement 100 may be configured to operatively produce an output signal (e.g. E_{A} or O_{A}) comprising one sub-channel BP1, BP2 for each data stream D1, D2 respectively at transmission conditions below a first value or similar by using a first modulation scheme with two (2) constellation points representing the information of each data stream D1, D2. FIG. 2 shows a first sub-channel BP1 centered at frequency f₁ comprising the information of the first data stream D1 and a second sub-channel BP2 centered at frequency f₂ comprising the information of the second data stream D2.

Before proceeding it should also be clarified that the first value and the second value and similar values mentioned herein may e.g. be represented by a SNR or a SINR or similar for any signal received via the transmission link 140. If the values are represented by a BER or BLER or similar then it is preferred that the values are determined as an inverse of the transmission conditions, e.g. 1/BER or 1/BLER or similar. The values in question may e.g. be a predetermined value, e.g. stored in a memory and/or set at the installation of the transmitter 100 and/or iteratively determined by the transmitter 100 in a dedicated process or similar.

The individual sub-channel BP1, BP2 for each data stream D1, D2 respectively may be produced by configuring the determining unit 120 to operatively detect transmission conditions below the first value or similar and to provide a separate unique frequency f₁, f₂ to each modulator unit 10a, 10b respectively to be modulated by the first data stream D1 and the second data stream D2 respectively. In other words, the first sub-channel BP1 may be produced by providing a first frequency f₁ to the first modulator unit 10a modulating the first frequency f₁ with the first data stream D1. The second sub-channel BP2 may be produced by providing a unique frequency f₂ to the second modulator unit 10b modulating the second frequency f₂ with the second data stream D2.

The output from each modulator unit 10a, 10b may be summarized in the summation unit 110. The summation function may e.g. be a separate unit or incorporated into the modulator units 10a, 10b.

The first sub-channel BP1 comprises the first data stream D1 conveyed by a Binary Phase-Shift Keying (BPSK) modulation scheme representing the information in the first data stream D1 by two constellation points A, A′. The second sub-channel BP2 comprises the second data stream D2 conveyed by a BPSK modulation scheme representing the information in the second data stream D2 by two constellation points B, B′.

### Second Modulation Scheme of Transmitter Arrangement 100

Furthermore, the transmitter arrangement 100 may be configured to operatively produce an output signal (e.g. E_{A} or O_{A}) comprising one single dual-stream sub-channel QP1 for all the data streams D1, D2 at transmission conditions above the first value and upwards, e.g. up to a second value, by using a second modulation scheme with four (4) constellation points representing the information of the pair of the two data streams D1, D2. FIG. 2 shows the single sub-channel QP1 centered at frequency f₁ comprising the information in the first data stream D1 and the second data stream D2.

The single dual-stream sub-channel QP1 may be produced by configuring the determining unit 120 to operatively detect transmission conditions above the first value and preferably below a second value or similar and to provide a separate unique frequency in-phase f₁ to the first modulator unit 10a and in quadrature f_{1+90°} to the second modulator unit 10b in the pair of the two modulator units 10a, 10b. The first modulator unit 10a modulates the in-phase frequency f₁ with the first data stream D1 and the second modulator unit 10b modulates the quadrature frequency f_{1+90°} (i.e. f_{1+90°} is phase shifted 90° with respect to f₁) with the second data stream D2 in the pair of the two individual data streams D1, D2.

In other words, the dual-stream sub-channel QP1 may be produced by providing a unique frequency in-phase f₁ to the first modulator unit 10a modulating the in-phase frequency f₁ with the first data stream D1, and by providing the unique frequency in quadrature f_{1+90°} to the second modulator unit 10b modulating the quadrature frequency f_{1+90°} with the second data stream D2.

The output from each modulator unit 10a, 10b may be summarized in the summation unit 110.

The dual-stream sub-channel QP1 comprises the first data stream D1 and the second data stream D2 conveyed by a Quadrature Phase Shift Keying (QPSK) modulation scheme representing the information in the data streams D1, D2 by four (4) constellation points A, A′, B, B′.

Before proceeding it should be noted that the exemplifying transmitter arrangement 100 only uses two (2) different modulation schemes (e.g. BPSK and QSPK). However, other parts of a more complex transmitter arrangement comprising the transmitter arrangement 100 now discussed may indeed use a third modulation scheme or further modulation schemes.

### Second Embodiment

### Transmitter Arrangement 200

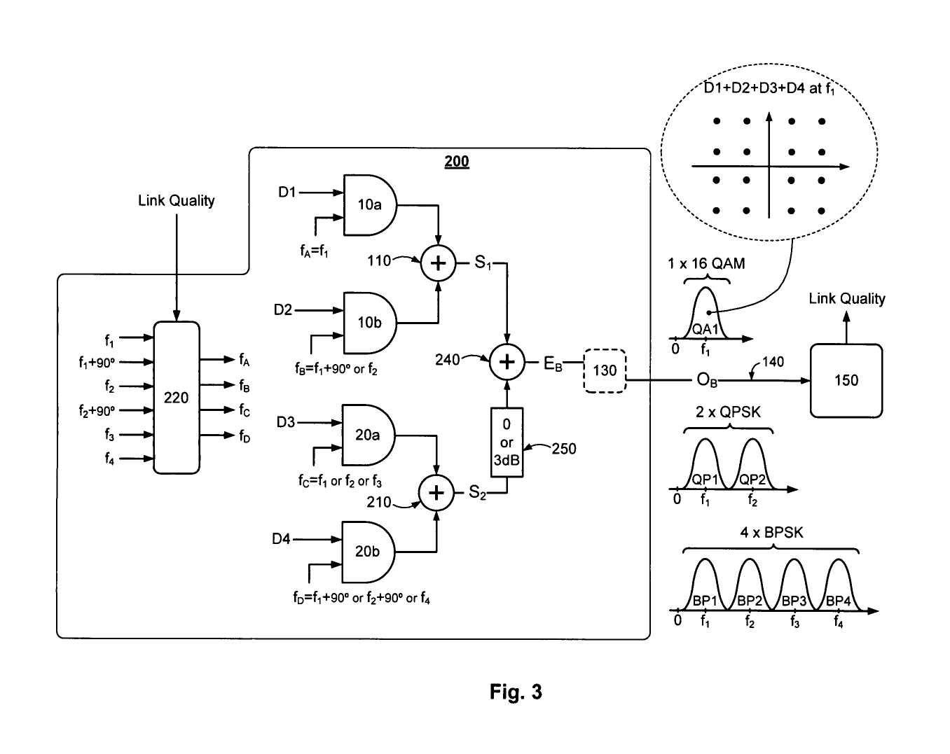

The attention is now directed to FIG. 3 showing a schematic illustration of a transmitter arrangement 200 according to another embodiment of the present solution. The transmitter arrangement 200 is configured to operatively transmit an optical signal O_{B} or an electrical signal E_{B} comprising four data streams D1, D2, D3, D4 distributed on a number of sub-channels. It is preferred that the transmitter is configured to operatively transmit the signal to a suitable receiver arrangement 150 via a suitable transmission link 140.

The transmitter arrangement 200 is configured to operatively obtain link quality information indicating the current transmission conditions for the transmission link 140. The transmitter arrangement 200 is configured to operatively determine a number of sub-channels in the signal (e.g. E_{B} or O_{B}) or similar based on the obtained transmission conditions, preferably such that the transmitted data throughput via the transmission link 140 remains unchanged and/or preferably such that the transmitted data throughput is equally distributed between the determined number of sub-channels.

Those skilled in the art having the benefit if this disclosure realises that the transmitter 200, the receiver 150 and the link 140 in FIG. 3 are the same or similar as the transmitter 100, the receiver 150 and the link 140 respectively in FIG. 2, except that the transmitter 200, the receiver 150 and the link 140 now handle four (4) data streams D1, D2, D3, D4 instead of two (2) data streams D1, D2.

Thus, the exemplifying transmitting arrangement 200 comprises a first modulator arrangement 10a, a second modulator arrangement 10b, a first summation unit 110, a determining unit 220 and preferably also an optical modulator arrangement 130. These features are the same or similar as the corresponding features in the transmitter arrangement 100 shown in FIG. 2.

In addition, the exemplifying transmitting arrangement 200 comprises a third modulator arrangement 20a, a fourth modulator arrangement 20b, a second summation unit 210 and a third summation unit 240.

It is preferred that the third modulator arrangement 20a and the fourth modulator arrangement 20b are of the same or similar kind as the modulator arrangements 10a, 10b respectively described above with reference to FIG. 2. It is also preferred that the second summation unit 210 and the third summation unit 240 are the same or similar kind as the summation unit 110 described above with reference to FIG. 2.

As can be seen in FIG. 3, it is preferred that the first summation unit 110 is configured to operatively summarize the modulated quadrature signal from the first modulator arrangement 10a and the modulated quadrature signal from the second modulator arrangement 10b so as to provide a first summarized quadrature output signal S₁. This is the same or similar as described above with respect to FIG. 2. Thus, the first output signal S₁ comprises the first data stream D1 and the second data stream D2.

In the same or similar manner it is also preferred that the second summation unit 210 is configured to operatively summarize the modulated quadrature signal from the third modulator arrangement 20a and the modulated quadrature signal from the fourth modulator arrangement 20b so as to provide a second summarized quadrature output signal S₂. Thus, the second output signal S₂ comprises the third data stream D3 and fourth data stream D4.

It is also preferred that the third summation unit 240 is configured to operatively add the first output signal S₁ and the second output signal S₂ so as to provide a third electrical summarized quadrature output signal E_{B}. The third output signal E_{B} may be transmitted directly via the transmission link 140. Alternatively, it may be provided to an optical modulator arrangement 130 so as to form and transmit an optical output signal O_{B} via the transmission link 140.

In addition it is preferred that the exemplifying transmitting arrangement 200 comprises an amplifying arrangement 250. The amplifying arrangement 250 is controlled by the determining unit 220 and configured to operatively amplify the first output signal S1 or the second output signal S2 before the signals S1, S2 are added in the third summation unit 240 as mentioned above. In FIG. 3 it is assumed that signal S2 is amplified with respect to signal S1. However, it should be emphasized that the amplifying arrangement 250 may instead attenuate signal S2, as long as the difference in amplitude between pair of signals S1 and S2 or similar is changed. This applies mutatis mutandis to the other embodiments presented herein. The amplifying arrangement 250 may e.g. be connected to or be a part of the determining unit 220.

It is preferred that the determining unit 220 of the transmitting arrangement 200 is configured to operatively produce or receive a unique signal comprising a unique frequency for each data stream D1, D2, D3, D4 operatively received by the transmitter arrangement 200. Thus, the determining unit 220 may e.g. be configured to produce or receive a first unique signal at a first unique frequency f₁ for data stream D1, a second unique signal at a second unique frequency f₂ for data stream D2, a third unique signal at a third unique frequency f₃ for data stream D3 and a fourth unique signal at a fourth unique frequency f₄ for data stream D4.

In addition, it is preferred that the determining unit 220 is configured to operatively produce or receive an unique phase-shifted signal for each unique signal (f₁, f₂, f₃, f₄) or at least for half of the unique signals or some other set of the unique signals as required in the specific embodiment of the present solution. The determining unit 220 may e.g. be configured to operatively produce or receive a first unique phase-shifted signal f_{1+90°} comprising a phase shifted version of the first unique signal at frequency f₁ and a second unique phase-shifted signal f_{2+90°} comprising a phase shifted version of the second unique signal at frequency f₂. It is preferred that each unique phase shifted signal is phase-shifted so as to receive a phase that is orthogonal with respect to the phase of the corresponding unique signal so as to produce an unique quadrature phase signal of the corresponding unique in-phase signal.

It is also preferred that the determining unit 220 comprises one output connected to each modulator arrangement respectively, e.g. one output f_{A}, f_{B}, f_{C}, f_{D} connected to modulator arrangement 10a, 10b, 20a, 20b respectively.

The attention is now directed to an exemplifying operation of the transmitter arrangement 200.

### First Modulation Scheme of Transmitter Arrangement 200

The transmitter arrangement 200 may be configured to operatively produce an output signal (e.g. E_{B} or O_{B}) comprising one sub-channel BP1, BP2, BP3, BP4 for each data stream D1, D2, D3, D4 respectively at transmission conditions below a first value or similar by using a first modulation scheme with two (2) constellation points representing the information of each data stream D1, D2, D3, D4. FIG. 3 shows a first sub-channel BP1 centered at frequency f₁ comprising the information of the first data stream D1, a second sub-channel BP2 centered at frequency f₂ comprising the information of the second data stream D2, a third sub-channel BP3 centered at frequency f₃ comprising the information of the third data stream D3 and a fourth sub-channel SB4 centered at frequency f₄ comprising the information of the fourth data stream D4.

The individual sub-channel BP1, BP2, BP3, BP4 for each data stream D1, D2, D3, D4 respectively may be produced by configuring the determining unit 220 to operatively detect transmission conditions below the first value or similar and to provide a separate unique frequency f₁, f₂, f₃, f₄ to each modulator unit 10a, 10b, 20a, 20b respectively to be modulated by the first data stream D1 and the second data stream D2 and the third data stream D3 and the fourth data stream D4 respectively. Here it is preferred that the determining unit 220 is configured to operatively control the amplifying arrangement 250 so as to operatively apply no amplification.

In other words, the first sub-channel BP1 may be produced by providing a first frequency f₁ to the first modulator unit 10a modulating the first frequency f₁ with the first data stream D1. The second sub-channel BP2 may be produced by providing a unique frequency f₂ to the second modulator unit 10b modulating the second frequency f₂ with the second data stream D2. The third sub-channel BP3 may be produced by providing a unique frequency f₃ to the third modulator unit 20a modulating the third frequency f₃ with the third data stream D3. The fourth sub-channel BP4 may be produced by providing a unique frequency f₄ to the fourth modulator unit 20b modulating the fourth frequency f₄ with the fourth data stream D4.

The output from the modulator units 10a, 10b may be summarized in the first summation unit 110 producing output signal S₁ and the output from the modulator units 20a, 20b may be summarized in the second summation unit 210 producing output signal S₂. In The output signals S₁, S₂ are in turn summarized in the third summation unit 240 producing output signal E_{B}. The summation functions may e.g. be separate units or incorporated into the modulator units 10a, 10b, 20a, 20b.

The first sub-channel BP1 comprises the first data stream D1 conveyed by a BPSK modulation scheme representing the information in the first data stream D1 by two (2) constellation points. The second sub-channel BP2 comprises the second data stream D2 conveyed by a BPSK modulation scheme representing the information in the second data stream D2 by two (2) constellation points. The third sub-channel BP3 comprises the third data stream D3 conveyed by a BPSK modulation scheme representing the information in the third data stream D3 by two (2) constellation points. The fourth sub-channel BP4 comprises the fourth data stream D4 conveyed by a BPSK modulation scheme representing the information in the fourth data stream D4 by two (2) constellation points. The BPSK modulation scheme now mentioned is the same as the BPSK modulation schemes described above with reference to transmitter arrangement 100 in FIG. 2, however now applied to each data stream in a set of four data streams D1, D2, D3, D4.

### Second Modulation Scheme of Transmitter Arrangement 200

Furthermore, the transmitter arrangement 200 may be configured to operatively produce an output signal (e.g. E_{B} or O_{B}) comprising one dual-stream sub-channel QP1 for data streams D1, D2 and one dual-stream sub-channel QP2 for data streams D3, D4 at transmission conditions above the first value and upwards by using a second modulation scheme with four (4) constellation points representing the information of each pair of two data streams D1, D2 and D3, D4 respectively. FIG. 3 shows a first dual-stream sub-channel QP1 centered at frequency f₁ comprising the information in the first data stream D1 and the second data stream D2, and a second dual-stream sub-channel QP2 centered at frequency f₂ comprising the information in the third data stream D3 and the fourth data stream D4.

The dual-stream sub-channels QP1 and QP2 may be produced by configuring the determining unit 220 to operatively detect transmission conditions above the first value and preferably below a second value or similar. The determining unit 220 may be further configured to operatively provide a separate unique frequency in-phase f₁ to the first modulator unit 10a and in quadrature f_{1+90°} to the second modulator unit 10b in the pair of the two modulator units 10a, 10b, and a separate unique frequency in-phase f₂ to the third modulator unit 20a and in quadrature f_{2+90°} to the fourth modulator unit 20b in the pair of the two modulator units 20a, 20b. The first modulator unit 10a modulates the in-phase frequency f₁ with the first data stream D1 and the second modulator unit 10b modulates the quadrature frequency f_{1+90°} with the second data stream D2 in the pair of the two individual data streams D1, D2. The third modulator unit 20a modulates the in-phase frequency f₂ with the third data stream D3 and the fourth modulator unit 20b modulates the quadrature frequency f_{2+90°} with the fourth data stream D4 in the pair of the two individual data streams D3, D4. Here it is preferred that the determining unit 220 is configured to operatively control the amplifying arrangement 250 so as to operatively apply no amplification.

In other words, the dual-stream sub-channel QP1 may be produced by providing a unique frequency in-phase f₁ to the first modulator unit 10a modulating the in-phase frequency f₁ with the first data stream D1, and by providing the same unique frequency in quadrature f_{1+90°} to the second modulator unit 10b modulating the quadrature frequency f_{1+90°} with the second data stream D2. The dual-stream sub-channel QP1 comprises the first data stream D1 and the second data stream D2 conveyed by a Quadrature Phase Shift Keying (QPSK) modulation scheme representing the information in the data streams D1, D2 by four (4) constellation points.

Similarly, the dual-stream sub-channel QP2 may be produced by providing a unique frequency in-phase f₂ to the third modulator unit 20a modulating the in-phase frequency f₂ with the third data stream D3, and by providing the same unique frequency in quadrature f_{2+90°} to the fourth modulator unit 20b modulating the quadrature frequency f_{2+90°} with the fourth data stream D4. The dual-stream sub-channel QP2 comprises the third data stream D3 and the fourth data stream D4 conveyed by a Quadrature Phase Shift Keying (QPSK) modulation scheme representing the information in the data streams D3, D4 by four (4) constellation points.

The outputs from the modulator units 10a, 10b, 20a, 20b are summarized in the summation units 110, 210, 240 as described above. The two QPSK modulation schemes now discussed are preferably the same as the QSPK modulation scheme described above with reference to the transmitter arrangement 100 in FIG. 2, however now applied to each pair D1, D2 and D3, D4 in the set of four data streams D1, D2, D3, D4.

### Third Modulation Scheme of Transmitter Arrangement 200

The exemplifying transmitter arrangement 200 may also be configured to operatively produce an output signal (e.g. E_{B} or O_{B}) comprising one single quartet-stream sub-channel QA1 for all the data streams D1, D2, D3, D4 at transmission conditions above the second value by using a third modulation scheme with sixteen (16) constellation points representing the information of all pairs of two data streams D1, D2 and D3, D4. FIG. 3 shows a single quartet-stream sub-channel QA1 centered at frequency f₁ comprising the information in the first data stream D1 and the second data stream D2, and the third data stream D3 and the fourth data stream D4. The sixteen (16) constellation points have been schematically illustrated in FIG. 3 by sixteen dots forming four quadrates or rectangles which in turn form a single quadrate or rectangle.

The single quartet-stream sub-channel QA1 may be produced by configuring the determining unit 220 to operatively detect transmission conditions above the second value. The determining unit 220 may be further configured to operatively provide a common frequency in-phase f₁ to the first modulator unit 10a and in quadrature f_{1+90°} to the second modulator unit 10b in the first pair of two modulator units 10a, 10b, and in-phase f₁ to the third modulator unit 20a and in quadrature f_{1+90°} to the fourth modulator unit 20b in the second pair of two modulator units 20a, 20b. The first modulator unit 10a modulates the in-phase frequency f₁ with the first data stream D1 and the second modulator unit 10b modulates the quadrature frequency f_{1+90°} with the second data stream D2 in the first pair of the two individual data streams D1, D2. The third modulator unit 20a modulates the in-phase frequency f₁ with the third data stream D3 and the fourth modulator unit 20b modulates the quadrature frequency f_{1+90°} with the fourth data stream D4 in the second pair of the two individual data streams D3, D4.

Here it is preferred that the determining unit 220 is configured to operatively control the amplifying arrangement 250 so as to operatively apply an amplification to the output signal S2 being the summarized output from the modulator units 20a, 20b as described above. The amplification may alternatively be applied to the output signal S1 being the summarized output from the modulator units 10a, 10. It is preferred that the amplification is such that the signal amplitude is approximately doubled (i.e. ×2).

In other words, the single quartet-stream sub-channel QA1 may be produced by providing a common frequency in-phase f₁ to the first modulator unit 10a modulating the in-phase frequency f₁ with the first data stream D1, and by providing the common frequency in quadrature f_{1+90°} to the second modulator unit 10b modulating the quadrature frequency f_{1+90°} with the second data stream D2, and by providing the common frequency in-phase f₁ to the third modulator unit 20a modulating the in-phase frequency f₁ with the third data stream D3, and by providing the common frequency in quadrature f_{1+90°} to the fourth modulator unit 20b modulating the quadrature frequency f_{1+90°} with the fourth data stream D4.

The outputs from the modulator units 10a, 10b, 20a, 20b (amplified or not) are added in the summation units 110, 210, 240 as described above.

The quartet-stream sub-channel QA1 comprises all four data streams D1, D2, D3, D4 conveyed by a 16-QAM modulation scheme representing the information in the data streams D1, D2, D3, D4 by sixteen (16) constellation points.

Before proceeding it should be noted that the third modulation scheme (16-QAM) as described above is preferably produced in that the data streams of each pair of two data streams D1, D2 and D3, D4 are summarized after modulation and each summarized pair is added with a sequential increase of 3 dB amplification so as to accomplish a modulation scheme with a higher number of constellation points for each added summarized pair. Here, the second pair D3, D4 is added to the first pair D1, D2 with amplification that approximately doubles (i.e. ×2) the signal amplitude so as to accomplish the third modulation scheme described above.

### Third Embodiment

### Transmitter Arrangement 300

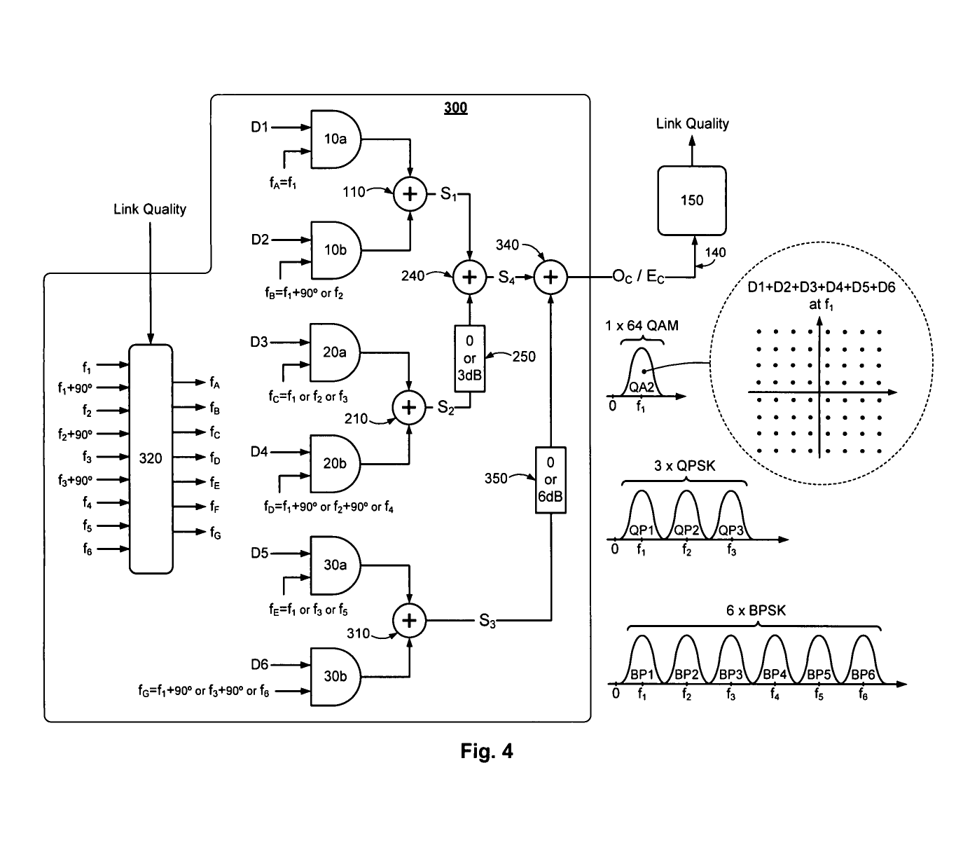

The attention is now directed to FIG. 4 showing a schematic illustration of a transmitter arrangement 300 according to another embodiment of the present solution. The transmitter arrangement 300 is configured to operatively transmit an optical signal O_{C} or an electrical signal E_{C} comprising six data streams D1, D2, D3, D4, D5, D6 distributed on a number of sub-channels. It is preferred that the transmitter is configured to operatively transmit the signal O_{C} or similar to a suitable receiver arrangement 150 via a suitable transmission link 140. To this end it is preferred that the transmitter arrangement 300 is provided with an optical modulator arrangement 130 (not shown) configured to provide the optical signal OC based on the electrical signal E_{C}.

The transmitter arrangement 300 is basically the same as the transmitter arrangement 200 discussed above with reference to FIG. 2.

Thus the transmitter arrangement 300 is configured to operatively obtain link quality information indicating the current transmission conditions for the transmission link 140 and to operatively determine the number of sub-channels in the signal (e.g. E_{C} or O_{C}) or similar based on the obtained transmission conditions, preferably such that the transmitted data throughput via the transmission link 140 remains unchanged and/or preferably such that the transmitted data throughput is equally distributed between the determined number of sub-channels.

The transmitting arrangement 300 comprises the first modulator arrangement 10a, the second modulator arrangement 10b, the first summation unit 110, the third modulator arrangement 20a, the fourth modulator arrangement 20b, the second summation unit 210, the third summation unit 240 and the amplifying arrangement 250. The transmitter arrangement 300 may also comprise the optical modulator arrangement 130 (not shown in FIG. 4). These features are the same or similar as the corresponding features in the transmitter arrangement 200 shown in FIG. 3.

In addition, the exemplifying transmitting arrangement 300 comprises a fifth modulator arrangement 30a, a sixth modulator arrangement 30b, a fourth summation unit 310, a fifth summation unit 340, a second amplifying arrangement 350 and a determining unit 320.

It is preferred that the fifth modulator arrangement 30a and the sixth modulator arrangement 30b are of the same or similar kind as the modulator arrangements 10a, 10b respectively described above with reference to FIG. 2. It is also preferred that the fourth summation unit 310 and the fifth summation unit 340 are the same or similar kind as the summation unit 110 described above with reference to FIG. 2.

As can be seen in FIG. 4, it is preferred that the fourth summation unit 310 is configured to operatively summarize the modulated quadrature signal from the fifth modulator arrangement 30a and the modulated quadrature signal from the sixth modulator arrangement 30b so as to provide a third summarized quadrature output signal S₃. Since the fifth modulator arrangement 30a receives the fifth data stream D5 and the sixth modulator arrangement 30b receives the sixth data stream D6 it follows that the third output signal S₃ comprises the fifth data stream D5 and the sixth data stream D6.

It is also preferred that the fifth summation unit 340 is configured to operatively receive the two added signals S₁ and S₂ from the third summation unit 240 and to operatively summarize signal S3 and the previously added signals S1 and S2 so as to provide an electrical summarized quadrature output signal E_{C}. The output signal E_{C} may be transmitted directly via the transmission link 140. The output signal E_{C} may be provided to an optical modulator arrangement 130 (not shown in FIG. 4) so as to form and transmit an optical output signal O_{C} via the transmission link 140. This is the same or similar as described above with reference to FIGS. 2 and 3.

In addition, it is preferred that the arrangement 200 comprises a further second amplifying arrangement 350. The second amplifying arrangement 350 is controlled by the determining unit 220 and configured to operatively amplify the summarized signal S3 before the signal S3 is added in the fifth summation unit 340 to provide the electrical output signal E_{C} mentioned above. The amplifying arrangement 350 may be connected to or be a part of the determining unit 320.

The determining unit 320 is preferably configured to operate in the same or similar manner as determining unit 220 discussed above with reference to FIG. 3. Thus the determining unit 320 may be configured to operatively produce or receive a unique signal comprising a unique frequency for each data stream D1, D2, D3, D4, D5, D6. The determining unit 320 may also be configured to operatively produce or receive an unique phase-shifted signal for each unique signal (f₁, f₂, f₃, f₄, f₅, f₆) or at least for half of the unique signals or some other set of the unique signals as required in the specific embodiment of the present solution.

Thus, the determining unit 320 may be configured to operatively produce or receive a first unique signal at a first unique frequency f₁, a second unique signal at a second unique frequency f₂, a third unique signal at a third unique frequency f₃, a fourth unique signal at a fourth unique frequency f₄, a fifth unique signal at a fifth unique frequency f₅, a sixth unique signal at a sixth unique frequency f₆, a first unique phase-shifted signal f_{1+90°} and a second unique phase-shifted signal f_{2+90°}, a third unique phase-shifted signal f_{3+90°} comprising a phase shifted version of the third unique signal at frequency f₃.

It is also preferred that the determining unit 320 comprises one output connected to each modulator arrangement respectively, e.g. one output f_{A}, f_{B}, f_{C}, f_{D}, f_{E}, f_{F}, f_{G} connected to modulator arrangement 10a, 10b, 20a, 20b, 30a, 30b respectively.

The attention is now directed to an exemplifying operation of the transmitter arrangement 300.

### First Modulation Scheme of Transmitter Arrangement 300

The transmitter arrangement 300 may be configured to operatively produce an output signal (e.g. E_{C} or O_{C}) comprising one sub-channel BP1, BP2, BP3, BP4, BP5, BP6 for each data stream D1, D2, D3, D4, D5, D6 respectively at transmission conditions below a first value or similar by using a first modulation scheme with two (2) constellation points representing the information of each data stream D1, D2, D3, D4, D5, D6. FIG. 4 shows a first sub-channel BP1 centered at frequency f₁ comprising the information of the first data stream D1, a second sub-channel BP2 centered at frequency f₂ comprising the information of the second data stream D2, a third sub-channel BP3 centered at frequency f₃ comprising the information of the third data stream D3 and a fourth sub-channel SB4 centered at frequency f₄ comprising the information of the fourth data stream D4, and a fifth sub-channel BP5 centered at frequency f₅ comprising the information of the fifth data stream D5, and a sixth sub-channel BP6 centered at frequency f₆ comprising the information of the sixth data stream D6.

The individual sub-channel BP1, BP2, BP3, BP4, BP5, BP6 for each data stream D1, D2, D3, D4, D5, D6 respectively may be produced by configuring the determining unit 320 to operatively detect transmission conditions below the first value or similar and to provide a separate unique frequency f₁, f₂, f₃, f₄, f₅, f₆ to each modulator unit 10a, 10b, 20a, 20b, 30a, 30b respectively to be modulated by the first data streams D1, D2, D3, D4, D5, D6 respectively, at the same time as the amplifying arrangements 250, 350 are controlled to operatively apply no amplification.

The output from the modulator units 10a, 10b may be summarized in summation unit 110 producing output signal S₁ and the output from the modulator units 20a, 20b may be summarized in summation unit 210 producing output signal S₂. The output signals S₁, S₂ are in turn summarized in the third summation unit 240 producing output signal S₄. In addition, the output from the modulator units 30a, 30b may be summarized in the fourth summation unit 310 producing output signal S₃. In turn, the output signals S3 and S4 are summarized in the fifth summation unit 340 so as to produce an output signal E_{C}/O_{C} comprising the sub-channels BP1, BP2, BP3, BP4, BPS, BP6 centered at frequency f₁, f₂, f₃, f₄, f₅, f₆ respectively.

The sub-channels BP1, BP2, BP3, BP4, BP5, BP6 comprises the data streams D1, D2, D3, D4, D5, D6 respectively each conveyed by a BPSK modulation scheme representing the information in the data streams by two (2) constellation points.

### Second Modulation Scheme of Transmitter Arrangement 300

The transmitter arrangement 300 may be configured to operatively produce an output signal (e.g. E_{C} or O_{C}) comprising three dual-stream sub-channels QP1, QP2, QP3 for each pair of two data streams D1, D2 and D3, D4 and D5, D6 respectively at transmission conditions below a first value or similar by using a second modulation scheme with four (4) constellation points representing the information of each pair of two data streams D1, D2 and D3, D4 and D5, D6 respectively. FIG. 4 shows a first dual-stream sub-channel QP1 centered at frequency f₁ comprising the information of the two data stream D1, D2 and a second dual-stream sub-channel QP2 centered at frequency f₂ comprising the information of the two data streams D3, D4 and a third dual-stream sub-channel QP3 centered at frequency f₃ comprising the information of the two data streams D5, D6.

Three dual-stream sub-channels QP1, QP2, QP3 may be produced for the first pair D1, D2 and the second pair D3, D4 and the third pair D5, D6 of two data streams respectively by configuring the determining unit 320 to operatively detect transmission conditions above the first value and below a second value. The determining unit 320 may be further configured to operatively provide a first separate unique frequency in-phase f₁ to unit 10a and in quadrature f_{1+90°} to modulator unit 10b, and a second separate unique frequency in-phase f₂ to modulator unit 20a and in quadrature f_{2+90°} to modulator unit 20b, and a third separate unique frequency in-phase f₃ to modulator unit 30a and in quadrature f_{3+90°} to modulator unit 30b. Modulator unit 10a modulates the in-phase frequency f₁ with the first data stream D1, modulator unit 10b modulates the quadrature frequency f_{1+90°} with the second data stream D2, modulator unit 20a modulates the in-phase frequency f₂ with the third data stream D3, modulator unit 20b modulates the quadrature frequency f_{2+90°} with the fourth data stream D4 modulator unit 30a modulates the in-phase frequency f₃ with the fifth data stream D5, modulator unit 30b modulates the quadrature frequency f_{3+90°} with the sixth data stream D6.

Here it is preferred that the determining unit 320 is configured to operatively control the amplifying arrangements 250, 350 so as to operatively apply no amplification.

The output from each modulator unit 10a, 10b, 20a, 20b, 30a, 30b is summarized in the summation units 110, 210, 240 as described above so as to produce an output signal E_{C}/O_{C} comprising the three dual-stream sub-channels QP1, QP2, QP3 centered at frequency f₁, f₂, f₃ respectively.

The dual-stream sub-channels QP1 and QP2 and QP3 comprises the data stream D1, D2 and D3, D4 and D5, D6 respectively conveyed by a QPSK modulation scheme representing the information in the data streams by four (4) constellation points.

### Third Modulation Scheme of Transmitter Arrangement 300

The transmitter arrangement 300 may be configured to operatively produce an output signal (e.g. E_{C} or O_{C}) comprising one single sextet-stream sub-channel QA2 for all data streams D1, D2, D3, D4, D5, D6 at transmission conditions above the second value by using a third modulation scheme with sixty-four (64) constellation points representing all pairs of two data streams D1, D2 and D3, D4 and D5, D6. FIG. 4 shows a sextet-stream sub-channel QA2 centered at frequency f₁ comprising the information in all the data streams D1, D2, D3, D4, D5, D6. The sixty-four (64) constellation points have been schematically illustrated by sixty-four dots forming a single quadrate or rectangle comprising four quadrates or rectangles with sixteen dots.

The single sextet-stream sub-channel QA2 may be produced by configuring the determining unit 320 to operatively detect transmission conditions above the second value, and to operatively provide a common frequency in-phase f₁ to the first modulator unit 10a, 20a, 30a and in quadrature f_{1+90°} to the second modulator unit 10b, 20b, 30b in each pair of two modulator units 10a, 10b and 20a, 20b and 30a, 30b. Modulator unit 10a modulates the in-phase frequency f₁ with the first data stream D1, modulator unit 10b modulates the quadrature frequency f_{1+90°} with the second data stream D2, modulator unit 20a modulates the in-phase frequency f₁ with the third data stream D3, modulator unit 20b modulates the quadrature frequency f_{1+90°} with the fourth data stream D4, modulator unit 30a modulates the in-phase frequency f₁ with the fifth data stream D5, modulator unit 30b modulates the quadrature frequency f_{1+90°} with the sixth data stream D6.

Here it is preferred that the determining unit 320 is configured to operatively control the amplifying arrangement 250 so as to operatively apply an amplification to the output signal S2, being the summarized output from the modulator units 20a, 20b. The amplification may alternatively be applied to the output signal S1, being the summarized output from the modulator units 10a, 10b. It is preferred that the amplification is such that the signal amplitude is approximately double (i.e. ×2)d. In addition, it is preferred that the determining unit 320 is configured to operatively control the amplifying arrangement 350 so as to operatively apply an amplification to the output signal S3, being the summarized output from the modulator units 30a, 30b. It is preferred that the additional amplification is such that the signal amplitude is approximately four doubled (i.e. ×4).

The outputs from the modulator units 10a, 10b, 20a, 20b, 30a, 30b (amplified or not) are summarized in the summation units 110, 210, 240 as described above.

The sextet-stream sub-channel QA2 comprises all six data streams D1, D2, D3, D4, D5, D6 conveyed by a 64-QAM modulation scheme representing the information in the data streams D1, D2, D3, D4, D5, D6 by sixty-four (64) constellation points.

Before proceeding it should be noted that the third modulation scheme as described above (64-QAM) is preferably produced in that the data streams of each pair of two data streams D1, D2 and D3, D4 and D5, D6 are summarized after modulation and each summarized pair is added with a sequential increase of 3 dB amplification so as to accomplish a modulation scheme with a higher number of constellation points for each added summarized pair. Here, the second pair D3, D4 is added to the first pair D1, D2 with amplification such that the signal amplitude is approximately doubled (i.e. ×2) and the third pair D5, D6 is then added with another doubling of the amplitude, i.e. a four doubling (i.e. ×4) so as to accomplish the third modulation scheme described above.

### Fourth Embodiment

### Transmitter Arrangement 400

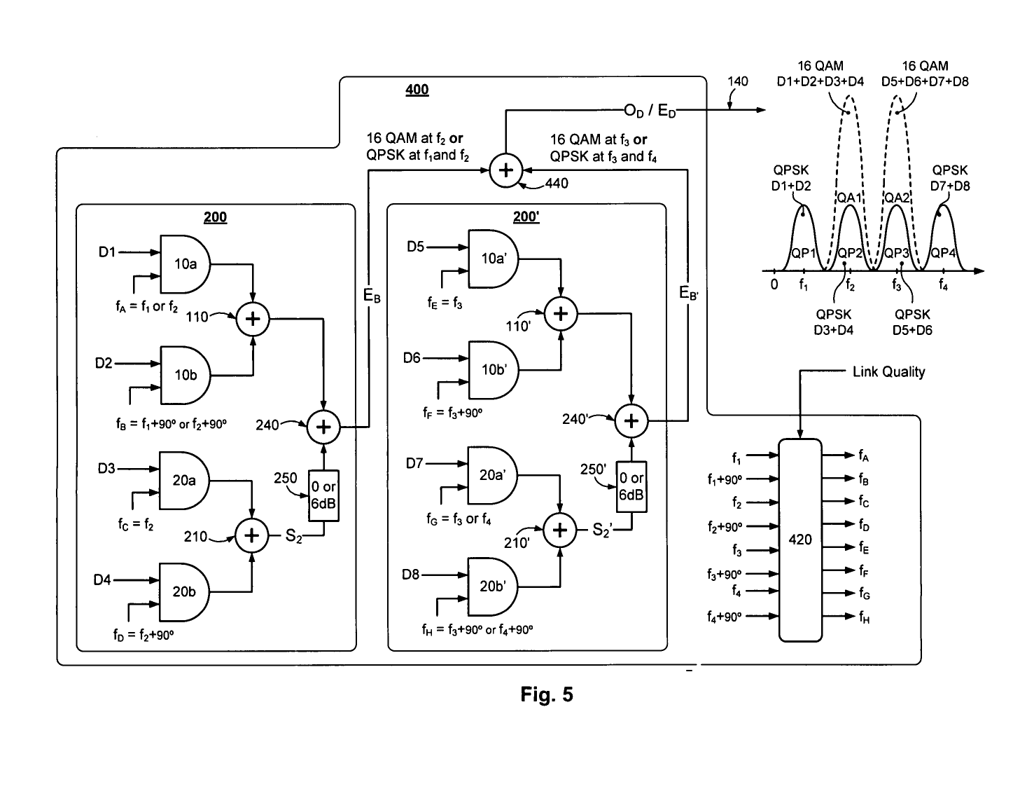

The attention is now directed to FIG. 5 showing a schematic illustration of a transmitter arrangement 400 according to another embodiment of the present solution. The transmitter arrangement 400 is configured to operatively transmit an optical signal O_{D} or an electrical signal E_{D} comprising eight data streams D1, D2, D3, D4, D5, D6 D7, D8 distributed on a number of sub-channels. It is preferred that the transmitter is configured to operatively transmit the signal O_{D} or similar to a suitable receiver arrangement 150 via a suitable transmission link 140. To this end it is preferred that the transmitter arrangement 400 is provided with an optical modulator arrangement 130 (not shown) configured to provide the optical signal O_{D} based on the electrical signal E_{D}.

The transmitter arrangement 400 comprises a first transmitter arrangement 200 and a second transmitter arrangement 200′, each being the same or similar as the transmitter arrangement 200 described above with reference to FIG. 3. Thus features 10a, 10b, 20a, 20b, 110, 210, 240 and 250 in transmitter arrangement 200 is of the same or similar kind as the corresponding features 10a′, 10b′, 20a′, 20b′, 110′, 210′, 240′ and 250′ respectively in transmitter arrangement 200′.

Moreover, the determining unit 420 of transmitter 400 may be the same or similar as the determining unit 220 of transmitter 200 in FIG. 3. For example the determining unit 420 may be configured to produce or receive a first unique signal at a first unique frequency f₁, a second unique signal at a second unique frequency f₂, a third unique signal at a third unique frequency f₃ and a fourth unique signal at a fourth unique frequency f₄, and a first unique phase-shifted signal f_{1+90°}, a second unique phase-shifted signal f_{2+90°}, a third unique phase-shifted signal f_{3+90°} and a fourth unique phase-shifted signal f_{4+90°}. It is also preferred that the determining unit 420 comprises one output connected to each modulator arrangement respectively, e.g. one output f_{A}, f_{B}, f_{C}, f_{D} f_{E}, f_{F}, f_{G}, f_{H} connected to modulator arrangement 10a, 10b, 20a, 20b, 10a′, 10b′, 20a′, 20b′ respectively.

### Second Modulation Scheme of Transmitter Arrangement 400

Before proceeding it should be noted that the exemplifying transmitter arrangement 400 only uses two (2) different modulation schemes (e.g. QSPK and 16-QAM). However, other parts of a more complex transmitter arrangement comprising the transmitter arrangement 400 now discussed may indeed use a first modulation scheme or further modulation schemes.

The first transmitter arrangement 200 of transmitter arrangement 400 is configured to operatively produce an output signal E_{B} comprising a first dual-stream sub-channel QP1 for data streams D1, D2 and one dual-stream sub-channel QP2 for data streams D3, D4 at transmission conditions above a first value and upwards by using a second modulation scheme (e.g. QPSK) with four (4) constellation points representing the information of each pair of two data streams D1, D2 and D3, D4 respectively. FIG. 5 shows a first dual-stream sub-channel QP1 centered at frequency f₁ comprising the information in the first data stream D1 and the second data stream D2, and a second dual-stream sub-channel QP2 centered at frequency f₂ comprising the information in the third data stream D3 and the fourth data stream D4. To this end it is preferred that the determining unit 420 of transmitter arrangement 400 is configured to operatively detect transmission conditions above the first value and preferably below a second value or similar and to operatively provide a first separate unique frequency in-phase f₁ to modulator unit 10a and in quadrature f_{1+90°} to modulator unit 10b, and a second separate unique frequency in-phase f₂ to modulator unit 20a and in quadrature f_{2+90°} to modulator unit 20b. Here it is preferred that the determining unit 420 is configured to operatively control the amplifying arrangement 250 so as to operatively apply no amplification.

Similarly, the second transmitter arrangement 200′ of transmitter arrangement 400 is configured to operatively produce an output signal E_{B′} comprising one dual-stream sub-channel QP3 for data streams D5, D6 and one dual-stream sub-channel QP4 for data streams D7, D8 at transmission conditions above a first value and upwards by using a second modulation scheme (e.g. QPSK) with four (4) constellation points representing the information of each pair of two data streams D5, D6 and D7, D8 respectively. FIG. 5 shows a third dual-stream sub-channel QP3 centered at frequency f₃ comprising the information in the fifth data stream D5 and the sixth data stream D6, and a fourth dual-stream sub-channel QP4 centered at frequency f₄ comprising the information in the seventh data stream D7 and the eight data stream D8. To this end it is preferred that the determining unit 420 of transmitter arrangement 400 is configured to operatively detect transmission conditions above the first value and preferably below a second value or similar and to operatively provide a third separate unique frequency in-phase f₃ to modulator unit 10a′ and in quadrature f_{3+90°} to modulator unit 10b′, and a separate fourth unique frequency in-phase f₄ to modulator unit 20a′ and in quadrature f_{4+90°} to modulator unit 20b′. It is further preferred that the determining unit 420 is configured to operatively control the amplifying arrangement 250 so as to operatively apply no amplification. Here it is preferred that the determining unit 420 is configured to operatively control the amplifying arrangement 250′ so as to operatively apply no amplification.

The output signals E_{B} and E_{B′} are summarized in the summation unit 440 so as to produce an output signal O_{D}/E_{D} comprising the dual-stream sub-channels QP1, QP2, QP3, Q4 centered at frequency f₁, f₂, f₃, f₄ respectively as described above.

The dual-stream sub-channels QP1 and QP2 and QP3 and QP4 comprises the data stream D1, D2 and D3, D4 and D5, D6 and D7, D8 respectively conveyed by a QPSK modulation scheme representing the information in the data streams by four (4) constellation points.

### Third Modulation Scheme of Transmitter Arrangement 400

The first transmitter arrangement 200 of transmitter arrangement 400 is configured to operatively produce an output signal E_{B} comprising a first quartet-stream sub-channel QA1 for all the data streams D1, D2, D3, D4 at transmission conditions above the second value by using a third modulation scheme (e.g. 16-QAM) with sixteen (16) constellation points representing the information of all pairs of two data streams D1, D2 and D3, D4. FIG. 5 shows the quartet-stream sub-channel QA1 centered at frequency f₁ comprising the information in the first data stream D1 and the second data stream D2, and the third data stream D3 and the fourth data stream D4.

The first quartet-stream sub-channel QA1 may be produced by configuring the determining unit 420 to operatively detect transmission conditions above the second value and to operatively provide a common frequency in-phase f₁ to modulator unit 10a and in quadrature f_{1+90°} to modulator unit 10b, and in-phase f₁ to modulator unit 20a and in quadrature f_{1+90°} to modulator unit 20b. Here it is preferred that the determining unit 420 is configured to operatively control the amplifying arrangement 250 so as to operatively apply an amplification to the output signal S2 from the modulator units 20a, 20b. It is preferred that the amplification amounts to approximately a four doubling of the signal amplitude (i.e. ×4).

Similarly, the second transmitter arrangement 200′ of transmitter arrangement 400 is configured to operatively produce an output signal E_{B}′ comprising a second quartet-stream sub-channel QA2 for all the data streams D5, D6, D7, D8 at transmission conditions above the second value by using a third modulation scheme (e.g. 16-QAM) with sixteen (16) constellation points representing the information of all pairs of two data streams D1, D2 and D3, D4. FIG. 5 shows the second quartet-stream sub-channel QA2 centered at frequency f₂ comprising the information in the fifth data stream D5 and the sixth data stream D6, and the seventh data stream D7 and the eight data stream D8.

The second quartet-stream sub-channel QA2 may be produced by configuring the determining unit 420 to operatively detect transmission conditions above the second value and to operatively provide a common frequency in-phase f₂ to modulator unit 10a′ and in quadrature f_{1+90°} to modulator unit 10b′, and in-phase f₂ to modulator unit 20a′ and in quadrature f_{2+90°} to modulator unit 20b′, 20b′. Here it is also preferred that the determining unit 420 is configured to operatively control the amplifying arrangement 250′ so as to operatively apply an amplification to the output signal S2′ being the summarized output from the modulator units 20a′, 20b′. It is preferred that the amplification amounts to approximately a four doubling of the signal amplitude (i.e. ×4).

### Fifth Embodiment

### Transmitter Arrangement 500

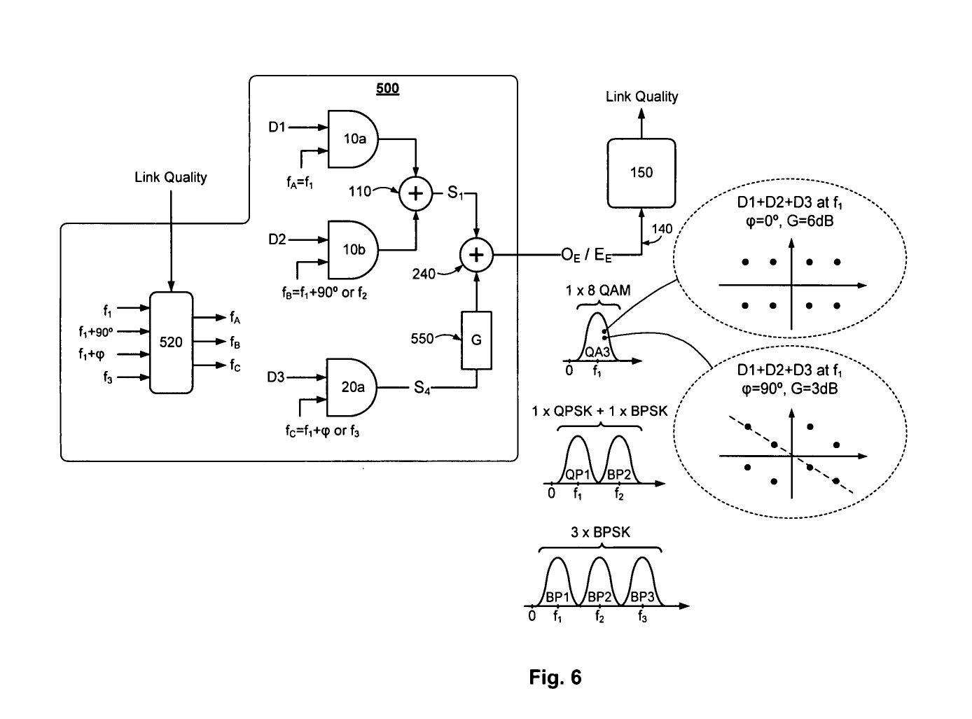

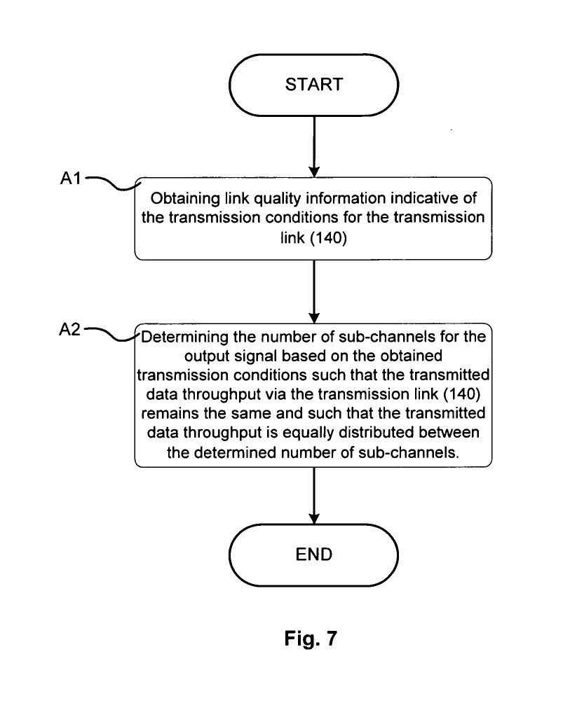

The attention is now directed to FIG. 6 showing a schematic illustration of a transmitter arrangement 500 according to another embodiment of the present solution. The transmitter arrangement 500 is configured to operatively transmit an optical signal O_{E} or an electrical signal E_{E} comprising three data streams D1, D2, D3 distributed on a number of sub-channels. It is preferred that the transmitter 500 is configured to operatively transmit the signal O_{E} or similar to a suitable receiver arrangement 150 via a suitable transmission link 140. To this end it is preferred that the transmitter arrangement 500 is provided with an optical modulator arrangement 130 (not shown) configured to provide the optical signal O_{E} based on the electrical signal E_{E}.

The features 10a, 10b, 20a, 110, 240 are preferably the same as the corresponding features in the transmitter arrangement 200 described above with reference to FIG. 3. Thus those skilled in the art having the benefit if this disclosure realise that the transmitter 500 is the same or similar as transmitter arrangement 200, except that transmitter 500 handles three (3) data streams D1, D2, D3 instead of four (4) data streams D1, D2, D3, D4 as will be discussed below.

The determining unit 520 of the transmitter arrangement 500 is configured to operate in the same or similar manner as determining unit 220 (discussed above with reference to FIG. 3) with respect to the modulator arrangements 10a, 10b. The determining unit 520 is configured to operatively produce or receive a first unique signal at a first unique frequency f₁, a second unique signal at a second unique frequency f₂, a third unique signal at a third unique frequency f₃ and a first unique phase-shifted signal f_{1+90°}. In addition, the determining unit 520 is configured to operatively produce or receive a second variable phase-shifted signal f₁₊₁₀₀ comprising a phase shifted version of the first unique signal at frequency f₁. The phase φ may e.g. be varied by shifting the propagation path of the signal between different delay lines or by using an appropriate phase shifting device or similar. Phase shifting a signal is a trivial and well known task to those skilled in the art and it needs no further explanation.

It is preferred that the determining unit 520 comprises one output connected to each modulator arrangement, e.g. one output f_{A}, f_{B}, f_{C} connected to modulator arrangement 10a, 10b, 20a respectively.

The amplifying arrangement 550 of the transmitter arrangement 500 is configured to operate in the same or similar manner as the amplifying arrangement 250 discussed above with reference to FIG. 3. The amplifying arrangement 550 is a variable amplifying arrangement controlled by the determining unit 520 to operatively apply a variable amplification to the output signal S4 from modulator unit 20a before the signal S4 is summarized in the summation 240 with the output signal S1 from the two modulation units 10a, 10b so as to provide an electrical output signal E_{E} as indicated above. A variable amplification may e.g. be accomplished by shifting the propagation path of signal S4 between different amplifiers or by using an appropriate amplification device providing a variable amplification of a signal or similar. Controlling a variable amplification of a signal is a well known task to those skilled in the art and it needs no particular explanation.

The attention is now directed to an exemplifying operation of the transmitter arrangement 500.

### First Modulation Scheme of Transmitter Arrangement 500

Transmitter arrangement 500 may be configured to operatively produce an output signal (e.g. E_{E} or O_{E}) comprising one sub-channel BP1, BP2, BP3 for each data stream D1, D2, D3 respectively at transmission conditions below a first value or similar by using a first modulation scheme (e.g. BPSK) with two (2) constellation points representing the information of each data stream D1, D2, D3 respectively. FIG. 6 shows a first sub-channel BP1 centered at frequency f₁ comprising the information of the first data stream D1, a second sub-channel BP2 centered at frequency f₂ comprising the information of the second data stream D2, a third sub-channel BP3 centered at frequency f₃ comprising the information of the third data stream D3.

An individual sub-channel BP1, BP2, BP3 for each data stream D1, D2, D3 respectively may be produced by configuring the determining unit 520 to operatively detect transmission conditions below the first value or similar and to provide a separate unique frequency f₁, f₂, f₃ to each modulator unit 10a, 10b, 20a respectively. Here it is preferred that the determining unit 520 is configured to operatively control the amplifying arrangements 110, 550 to operatively apply no amplification.

### Second Modulation Scheme of Transmitter Arrangement 500

In addition, the transmitter arrangement 500 may also be configured to operatively produce an output signal (e.g. E_{E} or O_{E}) comprising one dual-stream sub-channel QP1 for data streams D1, D3 and one single stream sub-channel BP2 for data stream D2 at transmission conditions above the first value and upwards, e.g. up to a second value, by using a second modulation scheme (e.g. QPSK) with four (4) constellation points representing the information of the pair of the two data streams D1, D3, and using the first modulation scheme (e.g. BPSK) with two (2) constellation points representing the information in the information of data stream D2. FIG. 6 shows the dual-stream sub-channel QP1 centered at frequency f₁ comprising the information in the first data stream D1 and the third data stream D3, and the single-stream sub-channel BP2 centered at frequency f₂ comprising the information in the second data stream D2.

The dual-stream sub-channel QP1 may be produced by configuring the determining unit 520 to operatively detect transmission conditions above the first value and preferably below a second value or similar and to provide a separate unique frequency in-phase f₁ to modulator unit 10a and in quadrature f_{1+90°} to modulator unit 20a, Thus, here the variable phase φ is set to +90°. In addition, the single-stream sub-channel BP2 may be produced by further configuring the determining unit 520 to operatively provide a separate unique frequency f₂ to modulator unit 10b. Here it is preferred that the determining unit 520 is configured to operatively control the amplifying arrangements 110, 550 to operatively apply no amplification.

### Second Modulation Scheme of Transmitter Arrangement 500

The transmitter arrangement 500 may also be configured to operatively produce an output signal (e.g. E_{E} or O_{E}) comprising a triple-stream sub-channel QA3 for all the data streams D1, D2, D3 at transmission conditions above the second value by using a third modulation scheme (e.g. 8-QAM) with eight (8) constellation points representing the information of all data streams D1, D2, D3. FIG. 6 shows the quartet-stream sub-channel QA3 centered at frequency f₁ comprising the information in the first data stream D1 and the second data stream D2, and the third data stream D3.

The triple-stream sub-channel QA3 may be produced by configuring the determining unit 520 to operatively detect transmission conditions above the second value and to operatively provide a common frequency in-phase f₁ to modulator units 10a and 20a and in quadrature f_{1+90°} to modulator unit 10b. Here it is preferred that the determining unit 520 is configured to operatively control the amplifying arrangement 550 so as to apply an amplification to the output signal S4. It is preferred that the amplification amounts to approximately a four doubling of the signal amplitude (i.e. ×4). In addition, it is preferred that determining unit 520 is configured to operatively control the phase φ of the signal at frequency f₁ to be 0°. This has been illustrated in the upper oval drawn with a dashed line FIG. 6 encircling eight (8) exemplifying constellation points of the third modulation scheme (e.g. 8-QAM) represented by eight (8) dots forming a rectangle.

However, the triple-stream sub-channel QA3 may be produced in alternative ways by varying the phase φ of the signal at frequency f₁ and/or by varying the amplification provided by the amplifying arrangement 550.

For example, the determining unit 520 may be configured to operatively control the amplifying arrangement 550 so as to apply an amplification to the output signal S₄ is such that the signal amplitude is approximately doubled (i.e. ×2). The determining unit 520 may also be configured to operatively control the phase φ of the signal at frequency f₁ to be +90°. This has been illustrated in the lower oval drawn with a dashed line FIG. 6 encircling eight (8) exemplifying constellation points of the third modulation scheme (e.g. 8-QAM) represented by eight (8) dots forming an irregular pattern wherein four (4) constellation points can be said to appear along a straight line, shown by a dashed line.

The selection of frequencies f1, f2, f3, f4, f4, f5, f6 or similar mentioned when describing some embodiments of the present solution above should be selected such that the sub-channels in the output signal of the transmitter arrangement can be readily separated/extracted in a receiver, e.g. such as the receiver 150 mentioned above. Preferably, the sub-channels should be arranged as closely as possible with respect to each other without leaving room for any other sub-channel between two neighbouring sub-channels, i.e. the sub-channels should be arranged adjacent to each other. This is a trivial task for a skilled person having the benefit of this disclosure. The task may e.g. be carried out by rough calculations and/or simple trial an error procedures.

The data throughput in the embodiments of the present solution discussed above can be kept at a substantially constant level even though the link quality for the transmission link 140 varies over time. This is an advantage in networks where the throughput should be upheld for various reasons, e.g. due to a guaranteed quality of service or similar.

Some embodiments of the present solution described above may be summarized in the following manner:

One embodiment may be directed to a method in a transmitter arrangement 200 for transmitting a signal OB comprising a number of data streams and a number of sub-channels to a receiver 150 via a transmission link 140. The method may comprise the following actions:
obtaining link quality information indicative of the transmission conditions for the transmission link 140,
determining the number of sub channels for the output signal based on obtained the transmission conditions such that the transmitted data throughput via the transmission link 140 remains the same and such that the transmitted data throughput is equally distributed between the determined number of sub channels.

The transmitter arrangement 200 may comprise one separate modulator arrangement for each pair of two separate data streams. The transmitter arrangement may be configured to operatively modulate a first frequency with a first unique data stream and a second frequency with a second unique data stream, and a summation arrangement and to operatively summarize the output from each modulator arrangement. The method in this transmitter arrangement may comprise the following actions:
at transmission conditions below a first value, setting every first frequency of each modulator arrangement to a unique frequency and every second frequency of each modulator arrangement to another unique frequency, so as to provide one sub channel for each data stream, the information of which is represented by n constellation points of a first modulation scheme,
at transmission conditions from the first value to a second higher value, setting every first frequency of each modulator arrangement to a unique frequency and the second frequency of each modulator arrangement to a phase shifted version of said unique first frequency having a quadrature phase shift, so as to provide one sub channel for each pair of two data streams the information of which is represented by m>n constellation points of a second modulation scheme,
at transmission conditions above the second value, setting the first frequency and the second frequency to the same frequency for all modulation arrangements, providing one sub channel for all data streams the information of which is represented by p>m constellation points of a third modulation scheme.

The transmitter arrangement may comprise one unique modulator unit for each unique data stream, which modulator is configured to modulate a frequency with a unique data stream, and a summation arrangement configured to summarize the output from each modulator unit. The method in this transmitter arrangement may comprise the following actions:
detecting transmission conditions below a first value and providing a unique frequency to each unique modulator unit modulating the unique frequency with a unique data stream so as to provide one sub-channel for each data stream wherein the information of the data stream is represented by n constellation points of a first modulation scheme,
detecting transmission conditions above the first value and below a second higher value and providing a unique frequency in-phase to the first modulator unit and in quadrature to the second modulator unit in each pair of two modulator units to modulate the unique in-phase frequency with a unique data stream and the unique quadrature frequency with another unique data stream so as to provide one sub-channel for each pair of two separate data streams wherein the information of the two data streams is represented by m>n constellation points of a second modulation scheme,
detecting transmission conditions above the second value and providing a common frequency in-phase to the first modulator unit and in quadrature to the second modulator unit in all pairs of two modulator units modulating each separate in-phase frequency with a unique data stream and each separate quadrature frequency with another unique data stream in each pair of two modulator units so as to provide one sub-channel for all data streams wherein the information of the data streams is represented by p>m constellation points of a third modulation scheme.

Each pair of two modulated data streams may be summarizes, i.e. added.

A first summarized pair (S1) and all other summarized pairs (S2) may be added with a sequentially increased amplitude for each added pair of two summarized modulated data streams at transmission conditions above the second value.

The sequentially increased amplitude may amount to a doubling of the amplitude for each added pair of two summarized modulated data streams.

The transmitter arrangement may comprise one unique modulator unit for each unique data stream, which modulator is configured to modulate a unique frequency with a unique data stream, and a summation arrangement configured to summarize the output from each modulator unit. The method in this transmitter arrangement may comprise the actions of:
detecting transmission conditions above a first value and below a second higher value and providing a unique frequency in phase to the first modulator unit and in quadrature to the second modulator unit in each pair of two modulator units to modulate each unique in phase frequency with a unique data stream, and each quadrature frequency with another unique data stream so as to provide one sub channel for each pair of two separate data streams wherein the information of the two data streams is represented by m≧4 constellation points of a modulation scheme,
detecting transmission conditions above the second value and providing a first common frequency in phase to the first modulator unit and in quadrature to the second modulator unit in a first half of all pairs of two modulator units, and a second common frequency in phase to the first modulator unit and in quadrature to the second modulator unit in a second half of all pairs of two modulator units so as to modulate each in phase frequency with a unique data stream and each quadrature frequency with another unique data stream in each pair of two modulator units so as to provide a first sub channel for the first half of all data streams and a second sub channel for the second half of all data streams wherein the information of the data streams is represented by p≧16 constellation points of another modulation scheme.

The method may comprise the actions of:
summarizing each pair of two modulated data streams in the first half of all data streams, and summarizing each pair of two modulated data streams in the second half of all data streams,
adding a first summarized pair and all other summarized pairs (S₂) for the first half of all data streams with a sequentially increased amplitude for each added pair of two summarized modulated data streams at transmission conditions above the second value,
adding a first summarized pair and all other summarized pairs (S₂′) for the second half of all data streams with a sequentially increased amplitude for each added pair of two summarized modulated data streams at transmission conditions above the second value.

It is preferred that each sub channel is centered on a separate frequency.

It is preferred that the frequencies set by the method are set such that the sub channels are provided adjacent to each other without any intermediate channels there between.

It is preferred that the first modulation scheme of the method is a binary phase shift keying, BPSK, scheme, and that the second modulation scheme or the one modulation scheme is a quadrature phase shift keying, QPSK, scheme and that the third modulation scheme is a quadrature amplitude modulation, QAM.

Some other embodiments of the present solution described above may be summarized in the following manner:

One embodiment may be directed to a transmitter arrangement configured to operatively transmit an output signal OB comprising a number of data streams and a number of sub-channels to a receiver 150 via a transmission link 140. A determining unit of the transmitter arrangement is configured to operatively:
obtain link quality information indicative of the transmission conditions for the transmission link,
determine the number of sub channels for the output signal based on obtained the transmission conditions such that the transmitted data throughput via the transmission link remains the same and such that the transmitted data throughput is equally distributed between the determined number of sub channels.

The link link quality information may e.g. be measured by the transmitter arrangement or it may e.g. be preprogrammed in the transmitter arrangement.

The transmitter arrangement may comprise one separate modulator arrangement for each pair of two unique data streams, which modulator arrangement is configured to modulate a first frequency with a first unique data stream and a second frequency with a second unique data stream, and a summation arrangement configured to summarize the output from each modulator arrangement, wherein the determining unit is configured to operatively set:
at transmission conditions below a first value, every first frequency of each modulator arrangement to a unique frequency and every second frequency of each modulator arrangement is set to another unique frequency, so as to provide one sub channel for each data stream, the information of which is represented by n constellation points of a first modulation scheme,
at transmission conditions from the first value to a second higher value, every first frequency of each modulator arrangement to a unique frequency and the second frequency of each modulator arrangement to a phase shifted version of said unique first frequency having a quadrature phase shift, so as to provide one sub channel for each pair of two data streams the information of which is represented by m>n constellation points of a second modulation scheme,
at transmission conditions above the second value, the first frequency and the second frequency are set to the same for all modulation arrangements, so as to provide one sub channel for all data streams the information of which is represented by p>m constellation points of a third modulation scheme.

The transmitter arrangement may comprise one separate modulator unit for each unique data stream, which modulator is configured to modulate a frequency with a unique data stream, and a summation arrangement configured to summarize the output from each modulator unit, wherein a determining unit is configured to detect transmission conditions:
below a first value and provide a unique frequency to each separate modulator unit to modulate the unique frequency with a unique data stream to provide one sub channel for each data stream wherein the information of the data stream is represented by n constellation points of a first modulation scheme,
above the first value and below a second higher value and provide a unique frequency in phase to the first modulator unit and in quadrature to the second modulator unit in each pair of two modulator units to modulate the unique in phase frequency with a unique data stream and the unique separate quadrature frequency with separate data stream to provide one sub channel for each pair of two separate data streams wherein the information of the two data streams is represented by m>n constellation points of a second modulation scheme,
above the second value and provide a common frequency in phase to the first modulator unit and in quadrature to the second modulator unit in all pairs of two modulator units to modulate each separate in phase frequency with a unique data stream and each separate quadrature frequency with another unique data stream in each pair of two modulator units to provide one sub channel QA1 for all data streams wherein the information of the data streams is represented by p>m constellation points of a third modulation scheme.

The summation arrangement of a transmitter arrangement may be configured to sum each pair of two modulated data streams.

The summation arrangement and an amplifying arrangement of a transmitter arrangement may be configured to operatively add a first summarized pair and all other summarized pairs with a sequentially increased amplitude for each added pair of two summarized modulated data streams at transmission conditions above the second value.

The amplifying arrangement of a transmitter arrangement may be configured to operatively increase the amplitude sequentially such that the sequentially increased amplitude amounts to a doubling of the amplitude for each added pair of two summarized modulated data stream.

The transmitter arrangement may comprise one separate modulator unit for each unique data stream that is configured to modulate a frequency with a separate data stream and a summation arrangement configured to summarize the output from each modulator unit, wherein the determining unit is configured to operatively detect transmission conditions:
above a first value and below a second higher value and provide a unique frequency in phase to the first modulator unit and in quadrature to the second modulator unit in each pair of two modulator units to modulate each separate in phase frequency with a unique data stream and each quadrature frequency with another unique data stream to provide one sub channel for each pair of two separate data streams wherein the information of the two data streams is represented by m≧4 constellation points of a modulation scheme,
above the second value and provide a first common frequency in phase to the first modulator unit and in quadrature to the second modulator unit in a first half of all pairs of two modulator units, and a second common frequency in phase to the first modulator unit and in quadrature to the second modulator unit in a second half of all pairs of two modulator units to modulate each in phase frequency with a unique data stream and each quadrature frequency with another unique data stream in each pair of two modulator units to provide a first sub channel for the first half of all data streams and a second sub channel for the second half of all data streams wherein the information of the data streams is represented by p≧16 constellation points of another modulation scheme.

The transmitter arrangement may have:
a first part of the summation arrangement that is configured to operatively summarize each pair of two modulated data streams in the first half of all data streams, and a second part of the summation arrangement that is configured to operatively summarize each pair of two modulated data streams in the second half of all data streams of the second half of all data streams,
a summation arrangement and an amplifying arrangement that are configured to add a first summarized pair and all other summarized pairs of the first half of all data streams with a sequentially increased amplitude for each added pair of two summarized modulated data streams at transmission conditions above the second value, and to add a first summarized pair and all other summarized pairs for the second half of all data streams with a sequentially increased amplitude for each added pair of two summarized modulated data streams at transmission conditions above the second value.

It is preferred that the transmitter arrangement is configured to operatively center each sub channel on a separate frequency.

It is preferred that the transmitter arrangement is configured to operatively set the frequencies such that the sub channels are provided adjacent to each other without any intermediate channels there between.

In the transmitter arrangement it is preferred that the first modulation scheme is a binary phase shift keying, BPSK, scheme, the second modulation scheme or the one modulation scheme is a quadrature phase shift keying, QPSK, scheme, and that the third modulation scheme is a quadrature amplitude modulation, QAM.

The present invention has now been described with reference to exemplifying embodiments. However, the invention is not limited to the embodiments described herein. On the contrary, the full extent of the invention is only determined by the scope of the appended claims.

1. A method in a transmitter apparatus for transmitting a signal comprising a number of data streams and a number of sub-channels to a receiver via a transmission link, comprising:
obtaining link quality information indicative of the transmission conditions for the transmission link; and
determining the number of sub-channels for the output signal based on the obtained link quality information such that the transmitted data throughput via the transmission link remains the same and such that the transmitted data throughput is equally distributed between the determined number of sub-channels.

2. The method according to claim 1, wherein the transmitter apparatus comprises one separate modulator for each pair of two separate data streams configured to modulate a first frequency with a first unique data stream and a second frequency with a second unique data stream, and a summation module configured to summarize the output from each modulator, wherein:
at transmission conditions below a first value, every first frequency of each modulator is set to a unique frequency and every second frequency of each modulator is set to another unique frequency, providing one sub-channel for each data stream, the information of which is represented by n constellation points of a first modulation scheme,
at transmission conditions from the first value to a second higher value, every first frequency of each modulator is set to a unique frequency and the second frequency of each modulator is set to a phase shifted version of said unique first frequency having a quadrature phase shift, providing one sub-channel for each pair of two data streams the information of which is represented by m>n constellation points of a second modulation scheme, at transmission conditions above the second value, the first frequency and the second frequency are set to the same frequency for all modulation arrangements, providing one sub-channel for all data streams the information of which is represented by p>m constellation points of a third modulation scheme.

3. The method according to claim 1, wherein the transmitter apparatus comprises one separate modulator unit for each unique data stream configured to modulate a frequency with a unique data stream and a summation arrangement configured to summarize the output from each modulator unit, wherein the method comprises:
detecting transmission conditions below a first value and providing a unique frequency to each separate modulator unit modulating the unique frequency with a unique data stream providing one sub-channel for each data stream wherein the information of the data stream is represented by n constellation points of a first modulation scheme,
detecting transmission conditions above the first value and below a second higher value and providing a unique frequency in-phase to the first modulator unit and in quadrature to the second modulator unit in each pair of two modulator units to modulate the unique in-phase frequency with a unique data stream and the unique quadrature frequency with another unique data stream providing one sub-channel for each pair of two separate data streams wherein the information of the two data streams is represented by m>n constellation points of a second modulation scheme,
detecting transmission conditions above the second value and providing a common frequency in-phase to the first modulator unit and in quadrature to the second modulator unit in all pairs of two modulator units modulating each separate in-phase frequency with a unique data stream and each separate quadrature frequency with another unique data stream in each pair of two modulator units providing one sub-channel for all data streams wherein the information of the data streams is represented by p>m constellation points of a third modulation scheme.

4. The method according to claim 2, further comprising summarizing each pair of two modulated data streams.

5. The method according to claim 4, further comprising:
adding a first summarized pair and all other summarized pairs with a sequentially increased amplitude for each added pair of two summarized modulated data streams at transmission conditions above the second value.

6. The method according to claim 5, wherein:
the sequentially increased amplitude amounts to a doubling of the amplitude for each added pair of two summarized modulated data streams.

7. The method according to claim 1, wherein the transmitter apparatus comprises one separate modulator unit for each unique data stream configured to modulate a frequency with a separate data stream and a summation arrangement configured to summarize the output from each modulator unit, wherein the method comprises:
detecting transmission conditions above a first value and below a second higher value and providing a unique frequency in-phase to the first modulator unit and in quadrature to the second modulator unit in each pair of two modulator units modulating each separate in-phase frequency with a unique data stream and each quadrature frequency with another unique data stream providing one sub-channel for each pair of two separate data streams wherein the information of the two data streams is represented by m≧4 constellation points of a modulation scheme,
detecting transmission conditions above the second value and providing a first common frequency in-phase to the first modulator unit and in quadrature to the second modulator unit in a first half of all pairs of two modulator units, and a second common frequency in-phase to the first modulator unit and in quadrature to the second modulator unit in a second half of all pairs of two modulator units to modulating each in-phase frequency with a unique data stream and each quadrature frequency with another unique data stream in each pair of two modulator units providing a first sub-channel for the first half of all data streams and a second sub-channel for the second half of all data streams wherein the information of the data streams is represented by p≧16 constellation points of another modulation scheme.

8. The method according to claim 7, wherein, the method comprises the actions of:
summarizing each pair of two modulated data streams in the first half of all data streams, and summarizing each pair of two modulated data streams in the second half of all data streams,
adding a first summarized pair and all other summarized pairs of the first half of all data streams with a sequentially increased amplitude for each added pair of two summarized modulated data streams at transmission conditions above the second value,
adding a first summarized pair and all other summarized pairs for the second half of all data streams with a sequentially increased amplitude for each added pair of two summarized modulated data streams at transmission conditions above the second value.

9. The method according to claim 1, wherein each sub-channel is centered on a separate frequency.

10. The method according to claim 2, comprising the steps of:
setting the frequencies such that the sub-channels are provided adjacent to each other without any intermediate channels there between.

11. The method according to claim 2, wherein:
the first modulation scheme is a binary phase-shift keying, BPSK, scheme,
the second modulation scheme or the one modulation scheme is a quadrature phase-shift keying, QPSK, scheme, or
the third modulation scheme is a quadrature amplitude modulation, QAM.

12. The method according to claim 1, wherein:
the output signal is an optical signal.

13. A transmitter apparatus configured to operatively transmit an output signal comprising a number of data streams and a number of sub-channels to a receiver via a transmission link, wherein a processor of the transmitter apparatus is configured to:
obtain link quality information indicative of the transmission conditions for the transmission link,
determine the number of sub-channels for the output signal based on obtained the transmission conditions such that the transmitted data throughput via the transmission link remains the same and such that the transmitted data throughput is equally distributed between the determined number of sub-channels.

14. The transmitter apparatus according to claim 13, wherein the transmitter apparatus comprises one separate modulator for each pair of two unique data streams configured to modulate a first frequency with a first unique data stream and a second frequency with a second unique data stream, and a summation arrangement configured to summarize the output from each modulator, wherein the processor is configured to operatively set:
at transmission conditions below a first value, every first frequency of each modulator to a unique frequency and every second frequency of each modulator is set to another unique frequency, so as to provide one sub-channel for each data stream, the information of which is represented by n constellation points of a first modulation scheme,
at transmission conditions from the first value to a second higher value, every first frequency of each modulator to a unique frequency and the second frequency of each modulator to a phase shifted version of said unique first frequency having a quadrature phase shift, so as to provide one sub-channel for each pair of two data streams the information of which is represented by m>n constellation points of a second modulation scheme,
at transmission conditions above the second value, the first frequency and the second frequency are set to the same for all modulation arrangements, so as to provide one sub-channel for all data streams the information of which is represented by p>m constellation points of a third modulation scheme.

15. The transmitter apparatus according to claim 13, comprising one separate modulator unit for each unique data stream configured to modulate a frequency with a unique data stream and a summation arrangement configured to summarize the output from each modulator unit, wherein the processor is configured to detect transmission conditions:
below a first value and provide a unique frequency to each separate modulator unit to modulate the unique frequency with a unique data stream to provide one sub-channel for each data stream wherein the information of the data stream is represented by n constellation points of a first modulation scheme,
above the first value and below a second higher value and provide a unique frequency in-phase to the first modulator unit and in quadrature to the second modulator unit in each pair of two modulator units to modulate the unique in-phase frequency with a unique data stream and the unique separate quadrature frequency with separate data stream to provide one sub-channel for each pair of two separate data streams wherein the information of the two data streams is represented by m>n constellation points of a second modulation scheme,
above the second value and provide a common frequency in-phase to the first modulator unit and in quadrature to the second modulator unit in all pairs of two modulator units to modulate each separate in-phase frequency with a unique data stream and each separate quadrature frequency with another unique data stream in each pair of two modulator units to provide one sub-channel for all data streams wherein the information of the data streams is represented by p>m constellation points of a third modulation scheme.

16. The transmitter apparatus according to claim 14, wherein the summation arrangement is configured to sum each pair of two modulated data streams.

17. The transmitter apparatus according to claim 16, wherein
the summation arrangement and an amplifying arrangement are configured to operatively add a first summarized pair and all other summarized pairs with a sequentially increased amplitude for each added pair of two summarized modulated data streams at transmission conditions above the second value.

18. The transmitter apparatus according to claim 17, wherein
the amplifying arrangement is configured to operatively increase the amplitude sequentially such that the sequentially increased amplitude amounts to a doubling of the amplitude for each added pair of two summarized modulated data stream.

19. The transmitter apparatus according to claim 13, comprising one separate modulator unit for each unique data stream configured to modulate a frequency with a separate data stream and a summation arrangement configured to summarize the output from each modulator unit, wherein the processor is configured to operatively detect transmission conditions:
above a first value and below a second higher value and provide a unique frequency in-phase to the first modulator unit and in quadrature to the second modulator unit in each pair of two modulator units to modulate each separate in-phase frequency with a unique data stream and each quadrature frequency with another unique data stream to provide one sub-channel for each pair of two separate data streams wherein the information of the two data streams is represented by m≧4 constellation points of a modulation scheme,
above the second value and provide a first common frequency in-phase (f2) to the first modulator unit and in quadrature to the second modulator unit in a first half of all pairs of two modulator units, and a second common frequency in-phase to the first modulator unit and in quadrature to the second modulator unit in a second half of all pairs of two modulator units to modulate each in-phase frequency with a unique data stream and each quadrature frequency with another unique data stream in each pair of two modulator units to provide a first sub-channel for the first half of all data streams and a second sub-channel for the second half of all data streams wherein the information of the data streams is represented by p≧16 constellation points of another modulation scheme.

20. The transmitter apparatus according to claim 19, wherein
a first part of the summation arrangement is configured to operatively summarize each pair of two modulated data streams in the first half of all data streams, and a second part of the summation arrangement is configured to operatively summarize each pair of two modulated data streams in the second half of all data streams of the second half of all data streams,
the summation arrangement and an amplifying arrangement are configured to add a first summarized pair and all other summarized pairs of the first half of all data streams with a sequentially increased amplitude for each added pair of two summarized modulated data streams at transmission conditions above the second value, and to add a first summarized pair and all other summarized pairs for the second half of all data streams with a sequentially increased amplitude for each added pair of two summarized modulated data streams at transmission conditions above the second value.

21. The transmitter apparatus according to claim 13, wherein:
each sub-channel is centered on a separate frequency.

22. The transmitter apparatus according to claim 14, wherein:
the frequencies are set such that the sub-channels are provided adjacent to each other without any intermediate channels there between.

23. The transmitter apparatus according to claim 15, wherein:
the first modulation scheme is a binary phase-shift keying, BPSK, scheme,
the second modulation scheme or the one modulation scheme is a quadrature phase-shift keying, QPSK, scheme, or
the third modulation scheme is a quadrature amplitude modulation, QAM.

24. The transmitter apparatus according to claim 13, wherein:
the transmitter apparatus is an optical transmitter apparatus and the output signal is an optical signal.
